(19) United States
(12) Patent Application Publication
(10) Pub. No.: US 2009/0212893 A1
(43) Pub. Date: Aug. 27, 2009

(54) CORROSION RESISTANT RARE EARTH MAGNETS AND PROCESS FOR PRODUCTION THEREOF

(75) Inventors: Ryuji HAMADA, Echizen-shi (JP); Takehisa MINOWA, Echizen-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHIN - ETSU CHEMICAL CO. , LTD., Tokyo (JP)

(21) Appl. No.: 12/385,909

(22) Filed: Apr. 23, 2009

Related U.S. Application Data
(62) Division of application No. 10/589,360, filed on Aug. 14, 2006.

(30) Foreign Application Priority Data
Jun. 30, 2004 (JP) 2004-194026
Jun. 30, 2004 (JP) 2004-194066
Jun. 30, 2004 (JP) 2004-194112

(51) Int. Cl. H01F 7/02; B05D 5/00

(52) U.S. Cl. 335/302; 427/127

(57) ABSTRACT

A corrosion resistant rare earth magnet is obtained by (i) applying a treating liquid comprising a flaky fine powder and a metal sol to a surface of R-T-M-B rare earth permanent magnet and then heating to form a composite film of flaky fine powder/metal oxide on the magnet surface; (ii) applying a treating liquid comprising a flaky fine powder and a silane and/or a partial hydrolyzate thereof to a surface of R-T-M-B rare earth permanent magnet and then heating a flaky fine powder/silane and/or partially hydrolyzed silane coating to form a composite film on the magnet surface; or (iii) applying a treating liquid comprising a flaky fine powder and an alkali silicate to a surface of R-T-M-B rare earth permanent magnet and then heating to form a composite film of flaky fine powder/alkali silicate glass on the magnet surface.

### CROSS-REFERENCE TO RELATED APPLICATION

This application is a divisional application of Ser. No. 10/589,360, filed Aug. 14, 2006 which is a National Stage Application under 35 U.S.C. § 371 of PCT/JP2005/011817 filed Jun. 28, 2005, which is based upon and claims the benefit of priority from the prior Japanese Patent Application Nos. 2004-194026 filed Jun. 30, 2004; 2004-194066 filed Jun. 30, 2004 and 2004-194112 filed Jun. 30, 2004, the entire contents of which are hereby incorporated by reference.

### TECHNICAL FIELD

This invention relates to corrosion resistant rare earth magnets in which rare earth magnets represented by R-T-M-B wherein R is at least one rare earth element inclusive of yttrium, T is iron or a mixture of iron and cobalt, and M is at least one element selected from among Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %, are improved in corrosion resistance; and methods for preparing the same.

### BACKGROUND ART

Due to excellent magnetic properties, rare earth permanent magnets are on widespread use in a variety of applications including various electric appliances and computer peripheral devices. They are electrical and electronic materials of importance. In particular, Nd-Fe-B base permanent magnets are quite excellent permanent magnets, as compared with Sm-Co base permanent magnets, in that the predominant element Nd exists in more plenty than Sm, the expense of raw materials is low due to savings of cobalt, and their magnetic properties surpass those of Sm-Co base permanent magnets. In these years, the Nd-Fe-B base permanent magnets are used in increasing amounts and in more widespread applications.

The Nd-Fe-B base permanent magnets, however, have the drawback that they are susceptible to oxidation in humid air within a brief time because they contain rare earth elements and iron as predominant components. When they are incorporated in magnetic circuits, some problems arise that the output of magnetic circuits is reduced by such oxidation and the periphery is contaminated with rust.

In particular, the Nd-Fe-B base permanent magnets have recently found use in motors such as automobile motors and elevator motors, where the magnets must work in a hot humid environment. It must be expected that the magnets are also exposed to salt moisture during the service. It is thus required to endow the magnets with corrosion resistance at low costs. Additionally, in the manufacture process of such motors, the magnets can be heated at or above 300° C., though briefly. In such a situation, the magnets must be heat resistant too.

For improving the corrosion resistance of Nd-Fe-B base permanent magnets, various surface treatments like resin coating, aluminum ion plating and nickel plating are often performed. With the state-of-the-art, however, it is difficult for such surface treatments to comply with the above-mentioned harsh conditions. For instance, resin coating is short of corrosion resistance and lacks heat resistance. Nickel plating is prone to rust in salt moisture because of the presence of pinholes, though a few. Ion plating generally has good heat resistance and corrosion resistance, but is difficult to perform at low costs because of a need for large-scale apparatus.

The references pertinent to the present invention include JP-A 2003-64454, JP-A 2003-158006, JP-A 2001-230107, and JP-A 2001-230108.

### DISCLOSURE OF THE INVENTION

### Problem to be Solved by the Invention

The present invention is made to provide R-T-M-B base rare earth permanent magnets such as Nd magnets which withstand the use under the above-mentioned harsh conditions; and its object is to provide corrosion resistant rare earth magnets in which the magnets are provided with corrosion resistant, heat resistant coatings, and methods for preparing the same.

### Means for Solving the Problem

Making extensive investigations to attain the above object, the inventor has found that a rare earth permanent magnet represented by R-T-M-B wherein R is at least one element selected from rare earth elements including yttrium, T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %, can be converted into a rare earth magnet having corrosion resistance and heat resistance through the treatment of (i) applying a treating liquid comprising at least one flaky fine powder selected from the group consisting of Al, Mg, Ca, Zn, Si, Mn, and alloys thereof and at least one metal sol selected from the group consisting of Al, Zr, Si, and Ti to a surface of the magnet and then heating to form a composite film of flaky fine powder/metal oxide on the magnet surface; or (ii) applying a treating liquid comprising at least one flaky fine powder selected from the group consisting of Al, Mg, Ca, Zn, Si, Mn, and alloys thereof and a silane and/or a partial hydrolyzate thereof to a surface of the magnet to form a coating of flaky fine powder/silane and/or partially hydrolyzed silane and heating it to form a composite film on the magnet surface; or (iii) applying a treating liquid comprising at least one flaky fine powder selected from the group consisting of Al, Mg, Ca, Zn, Si, Mn, and alloys thereof and an alkali silicate to a surface of the magnet and then heating to form a composite film of flaky fine powder/alkali silicate glass on the magnet surface. In these ways, rare earth magnets having corrosion resistance and heat resistance are obtainable. Determining several parameters on the basis of the above findings, the inventor has completed the present invention.

Accordingly, in a first aspect, the present invention provides a corrosion resistant rare earth magnet comprising a rare earth permanent magnet represented by R-T-M-B wherein R is at least one rare earth element including yttrium, T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %, and a composite film of flaky fine powder/metal oxide formed on a surface of said magnet by treating the surface with a treating liquid comprising at least one flaky fine powder selected from the group consisting of Al, Mg, Ca, Zn, Si, Mn, and alloys thereof and at least one metal sol selected from the group consisting of Al, Zr, Si, and Ti, followed by heating. As the means for obtaining the corrosion resistant rare earth magnet of the first aspect, the present invention also provides a method for preparing a corrosion resistant rare earth magnet, comprising the steps of applying a treating liquid comprising at least one flaky fine powder selected from the group consisting of Al, Mg, Ca, Zn, Si, Mn, and alloys thereof and at least one metal sol selected from the group consisting of Al, Zr, Si, and Ti to a surface of a rare earth permanent magnet, said rare earth permanent magnet being represented by R-T-M-B wherein R is at least one rare earth element including yttrium, T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %; and heating to form a composite film of flaky fine powder/metal oxide on the magnet surface.

In a second aspect, the present invention provides a corrosion resistant rare earth magnet comprising said rare earth permanent magnet and a composite film formed on a surface of said magnet by treating the surface with a treating liquid comprising at least one flaky fine powder selected from the group consisting of Al, Mg, Ca, Zn, Si, Mn, and alloys thereof and a silane and/or a partial hydrolyzate thereof, followed by heating. As the means for obtaining the corrosion resistant rare earth magnet of the second aspect, the present invention also provides a method for preparing a corrosion resistant rare earth magnet, comprising the steps of applying a treating liquid comprising at least one flaky fine powder selected from the group consisting of Al, Mg, Ca, Zn, Si, Mn, and alloys thereof and a silane and/or a partial hydrolyzate thereof to a surface of said rare earth permanent magnet to form a treatment coating of flaky fine powder/silane and/or partially hydrolyzed silane, and heating the treatment coating to form a composite film on the magnet surface. In one embodiment, the surface of the rare earth permanent magnet may be subjected to at least one pretreatment selected from pickling, alkaline cleaning and shot blasting, prior to the treatment with the treating liquid.

In a third aspect, the present invention provides a corrosion resistant rare earth magnet comprising said rare earth permanent magnet and a composite film of flaky fine powder/alkali silicate glass formed on a surface of said magnet by treating the surface with a treating liquid comprising at least one flaky fine powder selected from the group consisting of Al, Mg, Ca, Zn, Si, Mn, and alloys thereof and an alkali silicate, followed by heating. As the means for obtaining the corrosion resistant rare earth magnet of the third aspect, the present invention also provides a method for preparing a corrosion resistant rare earth magnet, comprising the steps of applying a treating liquid comprising at least one flaky fine powder selected from the group consisting of Al, Mg, Ca, Zn, Si, Mn, and alloys thereof and an alkali silicate to a surface of said rare earth permanent magnet, and heating to form a composite film of flaky fine powder/alkali silicate glass on the magnet surface.

### Benefits of the Invention

According to the invention, corrosion resistant rare earth magnets having heat resistance can be produced at low costs (i) by applying a treating liquid comprising at least one flaky fine powder selected from the group consisting of Al, Mg, Ca, Zn, Si, Mn, and alloys thereof and at least one metal sol selected from the group consisting of Al, Zr, Si, and Ti to a surface of the rare earth permanent magnet and then heating to provide a composite film of flaky fine powder/metal oxide to the magnet surface, or (ii) by applying a treating liquid comprising at least one flaky fine powder selected from the group consisting of Al, Mg, Ca, Zn, Si, Mn, and alloys thereof and a silane and/or a partial hydrolyzate thereof to a surface of the rare earth permanent magnet to form a coating of flaky fine powder/silane and/or partially hydrolyzed silane and heating it to provide a composite film to the magnet surface, or (iii) by applying a treating liquid comprising at least one flaky fine powder selected from the group consisting of Al, Mg, Ca, Zn, Si, Mn, and alloys thereof and an alkali silicate to a surface of the rare earth permanent magnet and then heating to provide a composite film of flaky fine powder/alkali silicate glass to the magnet surface. The invention is of great worth in the industry.

### BEST MODE FOR CARRYING OUT THE INVENTION

The rare earth permanent magnet used in the invention is a rare earth permanent magnet represented by R-T-M-B wherein R is at least one element selected from rare earth elements including yttrium, preferably neodymium or a combination of predominant neodymium with another rare earth element(s), T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %, typically a Nd-Fe-B permanent magnet.

Herein, R is a rare earth element inclusive of yttrium, and specifically at least one element selected from among Y, La, Ce, Pr, Nd, Sm, Eu, Gd, Tb, Dy, Ho, Er, Tm, Yb, and Lu. It is preferred that R comprise Nd. The content of Nd is preferably in the range: 5 wt %≦Nd≦37 wt %. The content of R is in the range: 5 wt %≦R≦40 wt %, and preferably 10 wt %≦R≦35 wt %.

T is iron or a mixture of iron and cobalt. The content of T is in the range: 50 wt %≦T≦90 wt %, and preferably 55 wt %≦T≦80 wt %. It is preferred that the proportion of cobalt in T be equal to or less than 10% by weight. M is at least one element selected from the group consisting of Ti, Nb, Al, V, Mn, Sn, Ca, Mg, Pb, Sb, Zn, Si, Zr, Cr, Ni, Cu, Ga, Mo, W, and Ta. The content of M is in the range: 0 wt %≦M≦8 wt %, and preferably O wt %≦M≦5 wt %.

Further, the magnet contains boron in an amount of 0.2 wt %≦B≦8 wt %, and preferably 0.5 wt %≦B≦5 wt %.

The R-T-M-B permanent magnets such as Nd-Fe-B permanent magnets as used herein are prepared by first melting raw material metals in vacuum or an inert gas, preferably in an argon atmosphere. The raw material metals used herein include pure rare earth elements, rare earth alloys, pure iron, ferroboron, and alloys thereof. It is understood that these metals contain incidental impurities which cannot be eliminated in the industrial manufacture, typically C, N, O, H, P and S. In the resulting alloy, alpha-Fe, R-rich phase or B-rich phase or the like can be left in addition to the R₂Fe₁₄B phase, and solution treatment may be optionally conducted. It may be a heat treatment in vacuum or an inert atmosphere like argon, at a temperature of 700 to 1,200° C. for at least one hour.

The source metal thus prepared is then pulverized in stages of coarse grinding and fine milling into a fine powder. The average particle size may be in a range of 0.5 to 20 μm. A size of less than 0.5 μm may be prone to oxidation, resulting in poor magnetic properties. A size of more than 20 μm may aggravate sinterability.

The fine powder is then compacted into a predetermined shape using a press for compacting in a magnetic field, followed by sintering. Sintering is carried out at a temperature in the range of 900 to 1,200° C. in vacuum or an inert atmosphere like argon, for at least 30 minutes. The sintering is followed by aging heat treatment at a lower temperature than the sintering temperature for at least 30 minutes.

For the magnet manufacture, there may be employed not only the aforementioned method, but also the so-called two-alloy method of preparing high-performance Nd magnets by mixing alloy powders of two different compositions and sintering the mixture. Japanese Patent No. 2853838, Japanese Patent No. 2853839, JP-A 5-21218, JP-A 5-21219, JP-A 5-74618, and JP-A 5-182814 propose methods of preparing Nd magnets by determining the compositions of two types of alloy while taking into account the type and characteristics of magnet-constituting phases, and combining them, for thereby producing high-performance Nd magnets having a good balance of high remanence (or residual magnetic flux density), high coercive force and high energy product. These manufacture methods may also be employed herein.

The permanent magnet used herein contains incidental impurities which cannot be eliminated in the industrial manufacture, typically C, N, O, H, P and S, but desirably in a total amount of equal to or less than 2% by weight. More than 2% by weight indicates the presence of more nonmagnetic components within the permanent magnet, which may detract from the remanence. Additionally, the rare earth elements can be consumed by these impurities, leading to under-sintering and lower coercive forces. A smaller total amount of impurities is preferred because both remanence and coercive force become higher.

According to the invention, any one of the following treatments (i), (ii), (iii) and combinations thereof is carried out on a surface of the resulting permanent magnet to form a composite film thereon, obtaining a corrosion resistant rare earth magnet.

Treatment (i) of applying a treating liquid comprising a flaky fine powder and a metal sol to a surface of the permanent magnet and then heating to form a composite film of flaky fine powder/metal oxide on the magnet surface.
Treatment (ii) of applying a treating liquid comprising a flaky fine powder and a silane and/or a partial hydrolyzate thereof to a surface of the permanent magnet to form a coating of flaky fine powder/silane and/or partially hydrolyzed silane and heating it to form a composite film on the magnet surface.
Treatment (iii) of applying a treating liquid comprising a flaky fine powder and an alkali silicate to a surface of the permanent magnet and then heating to form a composite film of flaky fine powder/alkali silicate glass on the magnet surface.

These treatments are described below in detail.

### First Treatment (i)

The first treatment uses a treating liquid comprising a flaky fine powder and a metal sol. The flaky fine powder used herein is of at least one metal selected from among Al, Mg, Ca, Zn, Si, and Mn, an alloy of two or more elements, and a mixture thereof. It is preferred to use a metal selected from among Al, Zn, Si, and Mn. The flaky fine powder used herein should preferably consist of particles of a shape having an average length of 0.1 to 15 μm, an average thickness of 0.01 to 5 μm, and an aspect ratio, given as average length/average thickness, of at least 2. More preferably, the flaky fine powder has an average length of 1 to 10 μm, an average thickness of 0.1 to 0.3 μm, and an aspect ratio, given as average length/average thickness, of at least 10. With an average length of less than 0.1 μm, flaky particles may not lay in parallel to the underlying magnet, leading to a loss of binding force or adhesion. With an average length of more than 15 μm, flakes can be lifted up by the solvent that evaporates from the treating liquid during heating process, so that flakes may not lay in parallel to the underlying magnet, resulting in a coating with poor binding force. Also for the dimensional accuracy of the coating, the average length is desirably equal to or less than 15 μm. Flakes with an average thickness of less than 0.01 μm can be oxidized on their surface in the flake preparing stage so that the coating may become brittle and less corrosion resistant. With an average thickness of more than 5 μm, the dispersion of flakes in the treating liquid is aggravated so that flakes tend to settle down or the treating liquid may become unstable, resulting in poor corrosion resistance. With an aspect ratio of less than 2, flakes are unlikely to lay in parallel to the underlying magnet, leading to a loss of binding force. No upper limit is imposed on the aspect ratio although an extremely high aspect ratio is undesired for economy. Most often, the upper limit of aspect ratio is 100. It is understood that the flaky fine powder used herein is commercially available. For example, Zn flakes are available under the trade name of Z1051 from Benda-Lutz, and Al flakes are available under the trade name of Alpaste 0100M from Toyo Aluminum Co., Ltd.

As used herein, the average length and average thickness of flaky fine powder are determined by taking a photograph under an optical microscope or electron microscope, measuring the length and thickness of particles, and calculating an average thereof.

The other component used herein is at least one metal sol selected from among Al, Zr, Si, and Ti. The metal sol may be prepared by hydrolyzing an alkoxide of at least one metal selected from among Al, Zr, Si, and Ti with water added or moisture to form a partially polymerized sol having a binding ability.

As just described, the metal sol used herein is one prepared by hydrolysis of a metal alkoxide. The metal alkoxide which can be used herein has the formula:

A(OR)ₐ

wherein A stands for Al, Zr, Si or Ti, “a” is the valence of the metal, and R stands for an alkyl group of 1 to 4 carbon atoms. The hydrolysis of such a metal alkoxide may be effected in an ordinary way.

The metal alkoxide used herein is commercially available. To maintain the sol stable, a boron-containing compound such as boric acid or boric acid salt may be added to the sol in an amount of at most 10% by weight of the sol liquid. Sometimes, the boron-containing compound such as boric acid or boric acid salt contributes to an improvement in corrosion resistance.

The solvent for the treating liquid may be water or an organic solvent. The amounts of flaky fine powder and metal sol blended in the treating liquid are selected so as to provide the contents of flaky fine powder and metal oxide in the composite film to be described later.

In preparing the treating liquid, various additives including dispersants, anti-settling agents, thickeners, anti-foaming agents, anti-skinning agents, desiccants, curing agents, anti-sagging agents, etc. may be added in amounts of at most 10% by weight for improving the performance thereof. Additionally, compounds such as zinc phosphates, zinc phosphites, calcium phosphites, aluminum phosphites, and aluminum phosphates may be added as corrosion-inhibiting pigments to the treating liquid in amounts of at most 20% by weight. These compounds capture metal ions which are dissolved out from the magnet and flaky fine powder, and form insolved complex, stabilizing the surface of Nd magnets or flaky metal fine particles through passivation.

In the practice of the invention, the treating liquid is applied to the magnet by dipping or coating, after which heat treatment is effected for curing. The dipping and coating techniques are not particularly limited. Any well-known technique may be used to form a coating from the treating liquid. A heating temperature of from 100° C. to less than 500° C. is desirably maintained for at least 30 minutes in vacuum, air or inert gas atmosphere. Cure can take place even at temperatures below 100° C., but a long period of holding is necessary and undesirable from the standpoint of production efficiency. Under-cure may result in low binding forces and poor corrosion resistance. Temperatures equal to or higher than 500° C. can damage the underlying magnet, causing to degrade magnetic properties. The upper limit of heating time is not critical although it is generally about 1 hour.

In forming the film, overcoating and heat treating steps may be repeated.

Through the heating, the metal sol converts to a metal oxide past a gel state. As a consequence, the treatment coating becomes a composite film having a structure in which flaky fine particles are bound by the metal oxide. Although the reason why the composite film of flaky fine powder/metal oxide exhibits high corrosion resistance is not well understood, it is believed that fine particles in the form of flakes generally lay in parallel to the underlying magnet and fully cover the magnet, achieving a barrier effect. When a metal or alloy having a more negative potential than the permanent magnet is used as the flaky fine powder, a so-called sacrificial corrosion-preventing effect is exerted that the particles are preferentially oxidized to restrain the underlying magnet from oxidation. There is another advantage that the composite film formed is of inorganic nature and has high heat resistance.

In the composite film thus formed, the flaky fine powder is preferably present in an amount of at least 40% by weight, more preferably at least 45% by weight, even more preferably at least 50% by weight, and most preferably at least 60% by weight. The upper limit of powder content is suitably selected although it is preferably up to 99.9% by weight, more preferably 99% by weight, and most preferably up to 95% by weight. Less than 40 wt % of the fine powder may be too small to fully cover the underlying magnet, leading to a decline of corrosion resistance.

In the composite film thus formed, the metal oxide is preferably present in an amount of at least 0.1% by weight, more preferably at least 1% by weight, and most preferably at least 5% by weight. The upper limit is preferably up to 60% by weight, more preferably up to 55% by weight, even most preferably up to 50% by weight, and most preferably up to 40% by weight. Less than 0.1 wt % of the metal oxide indicates a too small amount of binding component, which may result in short binding forces. More than 60 wt % may detract from corrosion resistance.

If the total of flaky fine powder and metal oxide does not reach 100% by weight of the composite film, the remainder consists of the above-mentioned additives and/or corrosion-inhibiting pigments.

It is desired that the film formed in the invention have a thickness in the range of 1 to 40 μm, preferably in the range of 5 to 25 μm. Less than 1 μm may lead to shortage of corrosion resistance whereas more than 40 μm may lead to lower binding forces and become liable to delamination. A further increase of the film thickness may bring a disadvantage to magnet use because the volume of R-Fe-B permanent magnet available for the same outline shape is reduced.

### Second Treatment (ii)

The second treatment uses a treating liquid comprising a flaky fine powder and a silane and/or a partial hydrolyzate thereof. The flaky fine powder used herein is of at least one metal selected from among Al, Mg, Ca, Zn, Si, and Mn, an alloy of two or more elements, and a mixture thereof. Otherwise, with respect to its shape (average length, average thickness, aspect ratio) and the like, the flaky fine powder is the same as that used in the first treatment (i).

The other component is a silane which is preferably selected from alkoxysilanes, more preferably trialkoxysilanes and dialkoxysilanes, and most preferably functional group-containing organoalkoxysilanes or silane coupling agents of the general formula:

R²R³₃₋ₐSi(OR¹)ₐ

wherein “a” is 2 or 3; R¹ is an alkyl group of 1 to 4 carbon atoms; R² is selected from organic groups of 2 to 10 carbon atoms, including alkenyl groups such as vinyl and allyl, epoxy-containing alkyl groups, and (meth)acryloxy-containing alkyl groups; and R³ is selected from the same organic groups as defined for R², alkyl groups of 1 to 6 carbon atoms such as methyl, ethyl and propyl, and phenyl.

Illustrative examples of the silane include vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, alone or in admixture of two or more. The silanes which can be used herein are commercially available.

The silane is partially hydrolyzed with water in the treating liquid or moisture whereby alkoxy groups are converted to silanol groups, exerting a binding ability. As a proportion of silanol groups formed at this point becomes higher, the binding ability becomes better, but the treating liquid itself becomes less stable. It is described in JP-A 58-80245 and the like that when a boron-containing compound such as boric acid or a boric acid salt is added to a treating liquid in an amount of at most 10% by weight, Si—O—B linkages are partially formed, contributing to the stabilization of the treating liquid. Also in the present invention, a boron-containing compound such as boric acid or a boric acid salt may be used in the above-defined range. In some cases, the boron-containing compound such as boric acid or a boric acid salt also contributes to an improvement in corrosion resistance.

The solvent for the treating liquid may be water or an organic solvent. The amounts of flaky fine powder and silane and/or partially hydrolyzed silane blended in the treating liquid are selected so as to provide the contents of flaky fine powder and condensate of silane and/or partially hydrolyzed silane in the composite film to be described later.

In preparing the treating liquid, various additives including dispersants, anti-settling agents, thickeners, anti-foaming agents, anti-skinning agents, desiccants, curing agents, anti-sagging agents, etc. may be added in amounts of at most 10% by weight for performance-improving purposes like improving the corrosion resistance of the film or improving the stability of the treating liquid. Additionally, compounds such as zinc phosphates, zinc phosphites, calcium phosphites, aluminum phosphites, and aluminum phosphates may be added as corrosion-inhibiting pigments to the treating liquid in amounts of at most 20% by weight. These compounds capture metal ions which are dissolved out from the magnet and flaky fine powder, and form insolved complex, stabilizing the surface of Nd magnets or flaky metal fine particles through passivation.

In the practice of the invention, the treating liquid is applied to the magnet by dipping or coating, after which heat treatment is effected for curing. The dipping and coating techniques are not particularly limited. Any well-known technique may be used to form a coating from the treating liquid. A heating temperature of from 100° C. to less than 500° C. is desirably maintained for at least 30 minutes in vacuum, air or inert gas atmosphere. The heating temperature is more preferably from 200° C. to 450° C. and even more preferably from 250° C. to 400° C. Cure can take place even at temperatures below 100° C., but a long period of holding is necessary and undesirable from the standpoint of production efficiency. Under-cure may result in low binding forces and poor corrosion resistance. Temperatures equal to or higher than 500° C. can damage the underlying magnet, causing to degrade magnetic properties. The upper limit of heating time is not critical although it is generally about 1 hour.

In forming the film, overcoating and heat treating steps may be repeated.

As a result of heating, the coating becomes a composite film having a structure in which flaky fine particles are reaction-bound by the condensate of silane and/or partially hydrolyzed silane. Although the reason why the composite film of flaky fine powder/silane and/or partially hydrolyzed silane exhibits high corrosion resistance is not well understood, it is believed that fine particles in the form of flakes generally lay in parallel to the underlying magnet and fully cover the magnet, achieving a barrier effect. When a metal or alloy having a more negative potential than the permanent magnet is used as the flaky fine powder, a so-called sacrificial corrosion-preventing effect is exerted that the particles are preferentially oxidized to restrain the underlying magnet from oxidation. There is another advantage that the composite film formed is of inorganic nature and has high heat resistance.

In the composite film thus formed, the flaky fine powder is preferably present in an amount of at least 40% by weight, more preferably at least 45% by weight, even more preferably at least 50% by weight, and most preferably at least 60% by weight. The upper limit of powder content is suitably selected although it is preferably up to 99.9% by weight, more preferably 99% by weight, and most preferably up to 95% by weight. Less than 40 wt % of the fine powder may be too small to fully cover the underlying magnet, leading to a decline of corrosion resistance.

In the composite film thus formed, the condensate of silane and/or partially hydrolyzed silane is preferably present in an amount of at least 0.1% by weight, more preferably at least 1% by weight, and most preferably at least 5% by weight. The upper limit is preferably up to 60% by weight, more preferably up to 55% by weight, even most preferably up to 50% by weight, and most preferably up to 40% by weight. Less than 0.1 wt % of the condensate indicates a too small amount of binding component, which may result in short binding forces. More than 60 wt % may detract from corrosion resistance.

If the total of flaky fine powder and condensate of silane and/or partially hydrolyzed silane does not reach 100% by weight of the composite film, the remainder consists of the above-mentioned additives and/or corrosion-inhibiting pigments.

It is desired that the composite film formed in the invention have a thickness in the range of 1 to 40 μm, preferably in the range of 5 to 25 μm. Less than 1 μm may lead to shortage of corrosion resistance whereas more than 40 μm may lead to lower binding forces and become liable to delamination. A further increase of the film thickness may bring a disadvantage to magnet use because the volume of R-Fe-B permanent magnet available for the same outline shape is reduced.

Third Treatment (iii)

The third treatment uses a treating liquid comprising a flaky fine powder and an alkali silicate. The flaky fine powder used herein is the same as that used in the first treatment (i).

The other component is an alkali silicate which is preferably at least one selected from lithium silicate, sodium silicate, potassium silicate, and ammonium silicate. These alkali silicates are commercially available.

The solvent for the treating liquid may be water. The amounts of flaky fine powder and alkali silicate blended in the treating liquid are selected so as to provide the contents of flaky fine powder and alkali silicate glass in the composite film to be described later.

In preparing the treating liquid, various additives including dispersants, anti-settling agents, thickeners, anti-foaming agents, anti-skinning agents, desiccants, curing agents, anti-sagging agents, etc. may be added in amounts of at most 10% by weight for improving the performance thereof. Additionally, compounds such as zinc phosphates, zinc phosphites, calcium phosphites, aluminum phosphites, and aluminum phosphates may be added as corrosion-inhibiting pigments to the treating liquid in amounts of at most 20% by weight. These compounds capture metal ions which are dissolved out from the magnet and flaky fine powder, and form insolved complex, stabilizing the surface of Nd magnets or flaky metal fine particles through passivation.

In the practice of the invention, the treating liquid is applied to the magnet by dipping or coating, after which heat treatment is effected for curing. The dipping and coating techniques are not particularly limited. Any well-known technique may be used to form a coating from the treating liquid. A heating temperature of from 100° C. to less than 500° C. is desirably maintained for at least 30 minutes in vacuum, air or inert gas atmosphere. Cure can take place even at temperatures below 100° C., but a long period of holding is necessary and undesirable from the standpoint of production efficiency. Under-cure may result in low binding forces and poor corrosion resistance. Temperatures equal to or higher than 500° C. can damage the underlying magnet, causing to degrade magnetic properties. The upper limit of heating time is not critical although it is generally about 1 hour.

In forming the film, overcoating and heat treating steps may be repeated.

Through the heating, the alkali silicate converts to an alkali silicate glass. As a consequence, the treatment coating becomes a composite film having a structure in which flaky fine particles are bound by the alkali silicate glass. Although the reason why the composite film of flaky fine powder/alkali silicate glass exhibits high corrosion resistance is not well understood, it is believed that fine particles in the form of flakes generally lay in parallel to the underlying magnet and fully cover the magnet, achieving a barrier effect. When a metal or alloy having a more negative potential than the permanent magnet is used as the flaky fine powder, a so-called sacrificial corrosion-preventing effect is exerted that the particles are preferentially oxidized to restrain the underlying magnet from oxidation. There is another advantage that the composite film formed is of inorganic nature and has high heat resistance.

In the composite film thus formed, the flaky fine powder is preferably present in an amount of at least 40% by weight, more preferably at least 45% by weight, even more preferably at least 50% by weight, and most preferably at least 60% by weight. The upper limit of powder content is suitably selected although it is preferably up to 99.9% by weight, more preferably 99% by weight, and most preferably up to 95% by weight. Less than 40 wt % of the fine powder may be too small to fully cover the underlying magnet, leading to a decline of corrosion resistance.

In the composite film thus formed, the alkali silicate glass is preferably present in an amount of at least 0.1% by weight, more preferably at least 1% by weight, and most preferably at least 5% by weight. The upper limit is preferably up to 60% by weight, more preferably up to 55% by weight, even most preferably up to 50% by weight, and most preferably up to 40% by weight. Less than 0.1 wt % of the alkali silicate glass indicates a too small amount of binding component, which may result in short binding forces. More than 60 wt % may detract from corrosion resistance.

If the total of flaky fine powder and alkali silicate glass does not reach 100% by weight of the composite film, the remainder consists of the above-mentioned additives and/or corrosion-inhibiting pigments.

It is desired that the film formed in the invention have a thickness in the range of 1 to 40 μm, preferably in the range of 5 to 25 μm. Less than 1 μm may lead to shortage of corrosion resistance whereas more than 40 μm may lead to lower binding forces and become liable to delamination. A further increase of the film thickness may bring a disadvantage to magnet use because the volume of R-Fe-B permanent magnet available for the same outline shape is reduced.

It is understood that in the practice of the invention, pretreatment may be effected on the surface of the magnet prior to the above treatment (i), (ii) or (iii). The pretreatment is at least one treatment selected from pickling, alkaline cleaning and shot blasting. Specifically effected is at least one pretreatment selected from (1) pickling+water washing+ultrasonic cleaning, (2) alkaline cleaning+water washing, (3) shot blasting, and other treatments.

The cleaning liquid used in pretreatment (1) is an aqueous solution containing at least one acid selected from among nitric acid, hydrochloric acid, acetic acid, citric acid, formic acid, sulfuric acid, hydrofluoric acid, permanganic acid, oxalic acid, hydroxyacetic acid, and phosphoric acid in a total amount of 1 to 20% by weight. The rare earth magnet may be dipped in the cleaning liquid which is kept at a temperature of normal temperature to 80° C. The pickling removes the oxide layer on the surface and helps improve the binding force of the composite film.

The alkaline cleaning liquid which can be used in pretreatment (2) is an aqueous solution containing at least one member selected from among sodium hydroxide, sodium carbonate, sodium orthosilicate, sodium metasilicate, trisodium phosphate, sodium cyanide, and chelating agents in a total amount of 5 to 200 g/L. The rare earth magnet may be dipped in the cleaning liquid which is kept at a temperature of normal temperature to 90° C. The alkaline cleaning is effective for removing oil and fat contaminants which have attached to the magnet surface and helps improve the binding force between the composite film and the magnet.

The blasting material used in pretreatment (3) may be ordinary ceramics, glass and plastics. Treatment may be conducted under a discharge pressure of 2 to 3 kgf/cm². The shot blasting removes the oxide layer on the magnet surface in a dry way and also helps improve the binding force.

### EXAMPLE

Examples and Comparative Examples are given below for illustrating the invention although the invention is not limited thereto.

It is noted that the average length and average thickness of flaky fine powder were determined by taking a photograph under an optical microscope, measuring the length and thickness of 20 particles, and calculating an average thereof.

The thickness of a composite film was determined by cutting a magnet sample having a film formed thereon, polishing the section, and observing the clean section under an optical microscope.

Test Piece

High-frequency melting in an argon atmosphere was followed by casting to form an ingot of the composition: 32Nd-1.2B-59.8Fe-7Co in weight ratio. The ingot was coarsely ground on a jaw crusher and then finely milled on a jet mill using nitrogen gas, obtaining a fine powder having an average particle size of 3.5 μm. The fine powder was then filled in a mold with a magnetic field of 10 kOe applied and compacted under a pressure of 1.0 t/cm². It was then sintered in vacuum at 1,100° C. for 2 hours and age-treated at 550° C. for one hour, yielding a permanent magnet. From the permanent magnet, a magnet disc having a diameter of 21 mm and a thickness of 5 mm was cut out. This was followed by barrel polishing and ultrasonic water washing, obtaining a test piece.

### Examples 1 to 4

As the treating liquid for forming a film, a sol was prepared by dispersing aluminum flakes and zinc flakes in a hydrolytic solution of a metal alkoxide listed in Table 1. The hydrolytic solution of metal alkoxide (sol) had been prepared by stirring a mixture of 50 wt % metal alkoxide, 44 wt % ethanol and 5 wt % deionized water in the presence of 1 wt % of hydrochloric acid having a molar concentration of 1 as a catalyst. The treating liquid was adjusted at this point such that the composite film as cured might contain 8 wt % of aluminum flakes (average length 3 μm, average thickness 0.2 pm) and 80 wt % of zinc flakes (average length 3 μm, average thickness 0.2 μm). The treating liquid was sprayed to the test piece through a spray gun so that the composite film might have a thickness of 10 μm, and then heated in a hot air drying furnace at 300° C. in air for 30 minutes, forming a film. The composite film as cured had the aluminum and zinc contents described just above while the remainder was an oxide derived from the hydrolytic solution of metal alkoxide (sol) listed in Table 1.

The thus prepared sample was subjected to performance tests as described below. The results are shown in Table 1.

### (1) Salt Spray Test

According to the neutral salt water spraying test of JIS Z-2371. While 5% edible salt in water was continuously sprayed at 35° C., the time passed until brown rust generated was measured as an index for evaluation.

(2) Film Appearance After 350° C./4 hr. Heating

The film was heated at 350° C. for 4 hours, after which any change in the outer appearance was visually examined.

TABLE 1

| | | | Film appearance |
|---|---|---|---|
| | | | after |
| | Type of | Salt spray test | 350° C./4 hr. |
| | metal alkoxide | (hr.) | heating |
| Example 1 | aluminum | 1,000 | intact |
| | isopropoxide | | |
| Example 2 | titanium | 1,000 | intact |
| | isopropoxide | | |
| Example 3 | ethyl silicate | 1,000 | intact |
| Example 4 | zirconium | 1,000 | intact |
| | butoxide | | |

### Comparative Examples 1 to 4

For comparison purposes, samples were prepared by forming films on the test pieces by aluminum ion plating, 5 nickel plating and epoxy resin coating while controlling so as to give a film thickness of 10 μm. A salt spray test was conducted on these samples. Also, the film was heated at 350° C. for 4 hours, after which any change in the outer appearance was visually examined. The results are shown in Table 2. It is seen that the permanent magnets of the invention have both corrosion resistance and heat resistance as compared with the otherwise surface treated permanent magnets.

TABLE 2

| | | | Film appearance |
|---|---|---|---|
| | | | after |
| | Surface | Salt spray test | 350° C./4 hr. |
| | treatment film | (hr.) | heating |
| Comparative | none | 1 | discolored |
| Example 1 | | | overall |
| Comparative | Al ion plating | 200 | intact |
| Example 2 | | | |
| Comparative | Ni plating | 50 | discolored, |
| Example 3 | | | local cracks |
| Comparative | resin coating | 100 | carbonized, |
| Example 4 | | | partial fusion |

### Examples 5 to 9

Samples were prepared using the treating liquid in Example 3 while changing only the film thickness. A crosshatch adhesion test and a salt spray test were conducted on these samples. The results are shown in Table 3. Too thin a film may lack corrosion resistance whereas too thick a film may have poor adhesion.

The crosshatch adhesion test is as follows.

### (3) Crosshatch Adhesion Test

According to the crosshatch test of JIS K-5400. Adhesion was evaluated by incising a film in lattice by a cutter knife to define 100 square sections of 1 mm, forcedly attaching Cellophane adhesive tape thereto, strongly pulling the tape apart at an angle of 45°, and counting the number of remaining sections.

TABLE 3

| | Film thickness | Salt spray test | Crosshatch |
|---|---|---|---|
| | (μm) | (hr.) | adhesion test |
| Example 5 | 0.5 | 50 | 100/100 |
| Example 6 | 1.0 | 500 | 100/100 |
| Example 7 | 10 | 1,000 | 100/100 |
| Example 8 | 40 | 2,000 | 100/100 |
| Example 9 | 50 | 2,000 | 80/100 |

### Examples 10 to 12

Samples were prepared as in Example 2 except that the content of flaky fine powder in the composite film was changed. A salt spray test was conducted on these samples. The flaky fine powder contained in the treating liquid was a powder mixture of flaky aluminum powder and flaky zinc powder (both average length 3 μm, average thickness 0.2 μm) in a weight ratio of 1:10. The weight percent of the powder mixture in the treating liquid was determined such that the content of flaky fine powder in the composite film might have the value shown in Table 4. It is noted that the remainder of the composite film other than the flaky fine powder was an oxide derived from the sol described in Example 2. The results of the salt spray test are shown in Table 4. Adjustment was made so as to give a film thickness of 10 μm. A film having a too low proportion of flaky fine powder may have poor corrosion resistance.

TABLE 4

| | Flaky fine powder content | Salt spray test |
|---|---|---|
| | (wt %) | (hr.) |
| Example 10 | 25 | 50 |
| Example 11 | 60 | 500 |
| Example 12 | 90 | 1,000 |

### Examples 13 to 25

Samples were prepared as in Example 1 except that the shape of flaky fine powder was changed. A crosshatch adhesion test and a salt spray test were conducted on these samples. Adjustment was made so as to give a film thickness of 10 μm. The results are shown in Table 5. It is seen from Examples 13 to 17 that adhesion may become poor if the average length is too short or too long. It is also seen from Examples 18 to 22 that corrosion resistance may become poor if the average thickness is too small or too large. It is seen from Examples 23 to 25 that adhesion may become poor if the aspect ratio is too low.

TABLE 5

| | | | Aspect | | |
|---|---|---|---|---|---|
| | | | ratio | | |
| | Average | Average | (average | Salt spray | Crosshatch |
| | length | thickness | length/ | test | adhesion |
| | (μm) | (μm) | thickness) | (hr.) | test |
| Example 13 | 0.05 | 0.01 | 5 | 1,000 | 80/100 |
| Example 14 | 0.1 | 0.02 | 5 | 1,000 | 100/100 |
| Example 15 | 2 | 0.2 | 10 | 1,000 | 100/100 |
| Example 16 | 15 | 0.5 | 30 | 1,000 | 100/100 |
| Example 17 | 20 | 0.5 | 40 | 1,000 | 80/100 |
| Example 18 | 0.1 | 0.005 | 20 | 500 | 100/100 |
| Example 19 | 0.1 | 0.01 | 10 | 1,000 | 100/100 |
| Example 20 | 2 | 0.2 | 10 | 1,000 | 100/100 |
| Example 21 | 15 | 5 | 3 | 1,000 | 100/100 |
| Example 22 | 15 | 6 | 2.5 | 500 | 100/100 |
| Example 23 | 0.75 | 0.5 | 1.5 | 1,000 | 80/100 |
| Example 24 | 1.0 | 0.5 | 2 | 1,000 | 100/100 |
| Example 25 | 10 | 0.5 | 20 | 1,000 | 100/100 |

### Examples 26 to 29

Samples were prepared by the same procedure as in Example 1 except that pretreatment as described below was conducted prior to the treatment with the treating liquid.

Pickling
composition: 10 vol % nitric acid+5 vol % sulfuric acid dip at 50° C. for 30 seconds

Alkaline Cleaning
composition: 10 g/L sodium hydroxide,
3 g/L sodium metasilicate, 10 g/L trisodium phosphate,
8 g/L sodium carbonate, 2 g/L surfactant
dip at 40° C. for 2 minutes

Shot Blasting
Aluminum oxide #220 was blasted under a discharge pressure of 2 kgf/cm².

The magnet having the film formed thereon was subjected to a pressure cooker test (PCT) at 120° C., 2 atmospheres, 200 hours, after which a crosshatch adhesion test was conducted. The results are shown in Table 6. It is evident that the binding force is improved by the pretreatment.

TABLE 6

| | | Crosshatch adhesion test |
|---|---|---|
| | Pretreatment | after PCT |
| Example 26 | none | 90/100 |
| Example 27 | pickling + water washing + | 100/100 |
| | ultrasonic cleaning | |
| Example 28 | alkaline cleaning + | 100/100 |
| | water washing | |
| Example 29 | shot blasting | 100/100 |

### Examples 30 to 39

As the treating liquid for forming a film, a dispersion was prepared by dispersing aluminum flakes and zinc flakes in water together with a silane listed in Table 7. The treating liquid was adjusted at this point such that the composite film as cured might contain 8 wt % of aluminum flakes (average length 3 μm, average thickness 0.2 μm) and 80 wt % of zinc flakes (average length 3 μm, average thickness 0.2 μm). The treating liquid was sprayed to the test piece through a spray gun so that the composite film might have a thickness of 10 μm, and then heated in a hot air drying furnace at 300° C. in air for 30 minutes, forming a film. The composite film as cured had the aluminum and zinc contents described just above while the remainder was a condensate of the silane and/or partially hydrolyzed silane listed in Table 7.

The thus prepared samples were subjected to the same performance tests as in Examples 1 to 4 [(1) salt spray test and (2) film appearance after 350° C./4 hr. heating]. The results are shown in Table 7.

TABLE 7

| | | | Film |
|---|---|---|---|
| | | Salt | appearance |
| | | spray | after |
| | | test | 350° C./4 hr. |
| | Type of silane | (hr.) | heating |
| Example 30 | vinyltrimethoxysilane | 1,000 | intact |
| Example 31 | vinyltriethoxysilane | 1,000 | intact |
| Example 32 | β-(3,4-epoxycyclohexyl)ethyl- | 1,000 | intact |
| | trimethoxysilane | | |
| Example 33 | γ-glycidoxypropyltrimethoxysilane | 1,000 | intact |
| Example 34 | γ-glycidoxypropylmethyl- | 1,000 | intact |
| | diethoxysilane | | |
| Example 35 | γ-glycidoxypropyltriethoxysilane | 1,000 | intact |
| Example 36 | γ-methacryloxypropylmethyl- | 1,000 | intact |
| | dimethoxysilane | | |
| Example 37 | γ- | 1,000 | intact |
| | methacryloxypropyltrimethoxysilane | | |
| Example 38 | γ-methacryloxypropylmethyl- | 1,000 | intact |
| | diethoxysilane | | |
| Example 39 | γ-methacryloxypropyltriethoxysilane | 1,000 | intact |

### Examples 40 to 44

Samples were prepared using the treating liquid in Example 32 while changing only the film thickness. As in Examples 5 to 9, a crosshatch adhesion test and a dsalt spray test were conducted on these samples. The results are shown in Table 8. Too thin a film may lack corrosion resistance whereas too thick a film may have poor adhesion.

TABLE 8

| | Film thickness | Salt spray test | Crosshatch |
|---|---|---|---|
| | (μm) | (hr.) | adhesion test |
| Example 40 | 0.5 | 50 | 100/100 |
| Example 41 | 1.0 | 500 | 100/100 |
| Example 42 | 10 | 1,000 | 100/100 |
| Example 43 | 40 | 2,000 | 100/100 |
| Example 44 | 50 | 2,000 | 80/100 |

### Examples 45 to 47

Samples were prepared as in Example 32 except that the content of flaky fine powder in the composite film was changed. A salt spray test was conducted on these samples. The flaky fine powder contained in the treating liquid was a powder mixture of flaky aluminum powder and flaky zinc powder (both average length 3 μm, average thickness 0.2 μm) in a weight ratio of 1:10. The weight percent of the powder mixture in the treating liquid was determined such that the content of flaky fine powder in the composite film might have the value shown in Table 9. It is noted that the remainder of the composite film other than the flaky fine powder was a condensate of silane and/or partially hydrolyzed silane derived from the silane described in Example 32. The results of the salt spray test are shown in Table 9. Adjustment was made so as to give a film thickness of 10 μm. A film having a too low proportion of flaky fine powder may have poor corrosion resistance.

TABLE 9

| | Flaky fine powder content | Salt spray test |
|---|---|---|
| | (wt %) | (hr.) |
| Example 45 | 25 | 50 |
| Example 46 | 60 | 500 |
| Example 47 | 90 | 1,000 |

### Examples 48 to 60

Samples were prepared as in Example 30 except that the shape of flaky fine powder was changed. A crosshatch adhesion test and a salt spray test were conducted on these samples. Adjustment was made so as to give a film thickness of 10 μm. The results are shown in Table 10. It is seen from Examples 48 to 52 that adhesion may become poor if the average length is too short or too long. It is also seen from Examples 53 to 57 that corrosion resistance may become poor if the average thickness is too small or too large. It is seen from Examples 58 to 60 that adhesion may become poor if the aspect ratio is too low.

TABLE 10

| | | | Aspect | | |
|---|---|---|---|---|---|
| | | | ratio | | |
| | Average | Average | (average | Salt spray | Crosshatch |
| | length | thickness | length/ | test | adhesion |
| | (μm) | (μm) | thickness) | (hr.) | test |
| Example 48 | 0.05 | 0.01 | 5 | 1,000 | 80/100 |
| Example 49 | 0.1 | 0.02 | 5 | 1,000 | 100/100 |
| Example 50 | 2 | 0.2 | 10 | 1,000 | 100/100 |
| Example 51 | 15 | 0.5 | 30 | 1,000 | 100/100 |
| Example 52 | 20 | 0.5 | 40 | 1,000 | 80/100 |
| Example 53 | 0.1 | 0.005 | 20 | 500 | 100/100 |
| Example 54 | 0.1 | 0.01 | 10 | 1,000 | 100/100 |
| Example 55 | 2 | 0.2 | 10 | 1,000 | 100/100 |
| Example 56 | 15 | 5 | 3 | 1,000 | 100/100 |
| Example 57 | 15 | 6 | 2.5 | 500 | 100/100 |
| Example 58 | 0.75 | 0.5 | 1.5 | 1,000 | 80/100 |
| Example 59 | 1.0 | 0.5 | 2 | 1,000 | 100/100 |
| Example 60 | 10 | 0.5 | 20 | 1,000 | 100/100 |

### Examples 61 to 64

Samples were prepared by the same procedure as in Example 30 except that pretreatment as described below was conducted prior to the treatment with the treating liquid.

Pickling
composition: 10 vol % nitric acid+5 vol % sulfuric acid dip at 50° for 30 seconds

Alkaline Cleaning
composition: 10 g/L sodium hydroxide,
3 g/L sodium metasilicate, 10 g/L trisodium phosphate,
8 g/L sodium carbonate, 2 g/L surfactant
dip at 40° C. for 2 minutes

Shot Blasting
Aluminum oxide #220 was blasted under a discharge pressure of 2 kgf/cm².

The magnet having the film formed thereon was subjected to a pressure cooker test (PCT) at 120° C., 2 atmospheres, 200 hours, after which a crosshatch adhesion test was conducted. The results are shown in Table 11. It is evident that the binding force is improved by the pretreatment.

TABLE 11

| | | Crosshatch adhesion test |
|---|---|---|
| | Pretreatment | after PCT |
| Example 61 | none | 90/100 |
| Example 62 | pickling + water washing + | 100/100 |
| | ultrasonic cleaning | |
| Example 63 | alkaline cleaning + | 100/100 |
| | water washing | |
| Example 64 | shot blasting | 100/100 |

### Examples 65 to 68

As the treating liquid for forming a film, a dispersion was prepared by dispersing aluminum flakes and zinc flakes in an alkali silicate listed in Table 12. The treating liquid was adjusted at this point such that the composite film as cured might contain 8 wt % of aluminum flakes (average length 3 μm, average thickness 0.2 μm) and 80 wt % of zinc flakes (average length 3 μm, average thickness 0.2 μm). The treating liquid was sprayed to the test piece through a spray gun so that the composite film might have a thickness of 10 μm, and then heated in a hot air drying furnace at 300° C. in air for 30 minutes, forming a film. The composite film as cured had the aluminum and zinc contents described just above while the remainder was an alkali silicate glass derived from the alkali silicate listed in Table 12.

The thus prepared samples were subjected to the same performance tests as in Examples 1 to 4 [(1) salt spray test and (2) film appearance after 350° C./4 hr. heating]. The results are shown in Table 12.

TABLE 12

| | | | Film appearance |
|---|---|---|---|
| | | | after |
| | Type of alkali | Salt spray test | 350° C./4 hr. |
| | silicate | (hr.) | heating |
| Example 65 | lithium silicate | 1,000 | intact |
| Example 66 | potassium | 1,000 | intact |
| | silicate | | |
| Example 67 | sodium silicate | 1,000 | intact |
| Example 68 | ammonium silicate | 1,000 | intact |

### Examples 69 to 73

Samples were prepared using the treating liquid in Example 65 while changing only the film thickness. As in Examples 5 to 9, a crosshatch adhesion test and a salt spray test were conducted on these samples. The results are shown in Table 13. Too thin a film may lack corrosion resistance whereas too thick a film may have poor adhesion.

TABLE 13

| | Film thickness | Salt spray test | Crosshatch |
|---|---|---|---|
| | (μm) | (hr.) | adhesion test |
| Example 69 | 0.5 | 50 | 100/100 |
| Example 70 | 1.0 | 500 | 100/100 |
| Example 71 | 10 | 1,000 | 100/100 |
| Example 72 | 40 | 2,000 | 100/100 |
| Example 73 | 50 | 2,000 | 80/100 |

### Examples 74 to 76

Samples were prepared as in Example 65 except that the content of flaky fine powder in the composite film was changed. A salt spray test was conducted on these samples. The flaky fine powder contained in the treating liquid was a powder mixture of flaky aluminum powder and flaky zinc powder (both average length 3 μm, average thickness 0.2 μm) in a weight ratio of 1:10. The weight percent of the powder mixture in the treating liquid was determined such that the content of flaky fine powder in the composite film might have the value shown in Table 14. It is noted that the remainder of the composite film other than the flaky fine powder was an alkali silicate glass derived from the alkali silicate described in Example 65. The results of the salt spray test are shown in Table 14. Adjustment was made so as to give a film thickness of 10 μm. A film having a too low proportion of flaky fine powder may have poor corrosion resistance.:

TABLE 14

| | |
|---|---|
| Flaky fine powder content | Salt spray test |
| (wt %) | (hr.) |

| | | |
|---|---|---|
| Example 74 | 25 | 50 |
| Example 75 | 60 | 500 |
| Example 76 | 90 | 1,000 |

### Examples 77 to 89

Samples were prepared as in Example 65 except that the shape of flaky fine powder was changed. A crosshatch adhesion test and a salt spray test were conducted on these samples. Adjustment was made so as to give a film thickness of 10 μm. The results are shown in Table 15. It is seen from Examples 77 to 81 that adhesion may become poor if the average length is too short or too long. It is also seen from Examples 82 to 86 that corrosion resistance may become poor if the average thickness is too small or too large. It is seen from Examples 87 to 89 that adhesion may become poor if the aspect ratio is too low.

TABLE 15

| | | | Aspect | | |
|---|---|---|---|---|---|
| | | | ratio | | |
| | Average | Average | (average | Salt spray | Crosshatch |
| | length | thickness | length/ | test | adhesion |
| | (μm) | (μm) | thickness) | (hr.) | test |
| Example 77 | 0.05 | 0.01 | 5 | 1,000 | 80/100 |
| Example 78 | 0.1 | 0.02 | 5 | 1,000 | 100/100 |
| Example 79 | 2 | 0.2 | 10 | 1,000 | 100/100 |
| Example 80 | 15 | 0.5 | 30 | 1,000 | 100/100 |
| Example 81 | 20 | 0.5 | 40 | 1,000 | 80/100 |
| Example 82 | 0.1 | 0.005 | 20 | 500 | 100/100 |
| Example 83 | 0.1 | 0.01 | 10 | 1,000 | 100/100 |
| Example 84 | 2 | 0.2 | 10 | 1,000 | 100/100 |
| Example 85 | 15 | 5 | 3 | 1,000 | 100/100 |
| Example 86 | 15 | 6 | 2.5 | 500 | 100/100 |
| Example 87 | 0.75 | 0.5 | 1.5 | 1,000 | 80/100 |
| Example 88 | 1.0 | 0.5 | 2 | 1,000 | 100/100 |
| Example 89 | 10 | 0.5 | 20 | 1,000 | 100/100 |

### Examples 90 to 93

Samples were prepared by the same procedure as in Example 65 except that pretreatment as described below was conducted prior to the treatment with the treating liquid.

Pickling
composition: 10 vol % nitric acid+5 vol % sulfuric acid
dip at 50° C. for 30 seconds

Alkaline Cleaning
composition: 10 g/L sodium hydroxide,
3 g/L sodium metasilicate, 10 g/L trisodium phosphate,
8 g/L sodium carbonate, 2 g/L surfactant
dip at 40° C. for 2 minutes

Shot Blasting
Aluminum oxide #220 was blasted under a discharge pressure of 2 kgf/cm².

The magnet having the film formed thereon was subjected to a pressure cooker test (PCT) at 120° C., 2 atmospheres, 200 hours, after which a crosshatch adhesion test was conducted. The results are shown in Table 16. It is evident that the binding force is improved by the pretreatment.

TABLE 16

| | | Crosshatch adhesion test |
|---|---|---|
| | Pretreatment | after PCT |
| Example 90 | none | 90/100 |
| Example 91 | pickling + water washing + | 100/100 |
| | ultrasonic cleaning | |
| Example 92 | alkaline cleaning + | 100/100 |
| | water washing | |
| Example 93 | shot blasting | 100/100 |

1. A corrosion resistant rare earth magnet comprising
a rare earth permanent magnet represented by R-T-M-B wherein R is at least one rare earth element including yttrium, T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %≦R≦40 wt %, 50 wt %≦T≦90 wt %, 0 wt %≦M≦8 wt %, and 0.2 wt %≦B≦8 wt %, and
a composite film of flaky fine powder/metal oxide formed on a surface of said magnet by treating the surface with a treating liquid comprising at least one flaky fine powder selected from the group consisting of Al, Mg, Ca, Zn, Si, Mn, and alloys thereof and at least one metal sol selected from the group consisting of Al, Zr, Si, and Ti, followed by heating.

2. A corrosion resistant rare earth magnet according to claim 1, wherein said flaky fine powder of which the composite film is made consists of particles of a shape having an average length of 0.1 to 15 μm, an average thickness of 0.01 to 5 μm, and an aspect ratio, given as average length/average thickness, of at least 2, and the flaky fine powder is present in the composite film in an amount of at least 40 wt %.

3. A corrosion resistant rare earth magnet according to claim 1 or 2, wherein said metal sol has been prepared by hydrolysis of an alkoxide of a metal selected from the group consisting of Al, Zr, Si, and Ti.

4. A method for preparing a corrosion resistant rare earth magnet, comprising the steps of:
applying a treating liquid comprising at least one flaky fine powder selected from the group consisting of Al, Mg, Ca, Zn, Si, Mn, and alloys thereof and at least one metal sol selected from the group consisting of Al, Zr, Si, and Ti to a surface of a rare earth permanent magnet, said rare earth permanent magnet being represented by R-T-M-B wherein R is at least one rare earth element including yttrium, T is iron or a mixture of iron and cobalt, and M is at least one element selected from the group consisting of Ti, Nb, Al, V, Mn, Sn, Ca, Mg, Pb, Sb, Zn, Si, Zr, Cr, Ni, Cu, Ga, Mo, W, and Ta, and the contents of these elements are in the ranges: 5 wt %<R<40 wt %, 50 wt %≦T≦90 wt %, 0 wt %≦M≦8 wt %, and 0.2 wt %≦B≦8 wt %, and
heating to form a composite film of flaky fine powder/metal oxide on the magnet surface.

5. A method for preparing a corrosion resistant rare earth magnet according to claim 4, further comprising the step of subjecting the rare earth permanent magnet surface to at least one pretreatment selected from pickling, alkaline cleaning and shot blasting, prior to the applying step.
